(19) United States
(12) Patent Application Publication
(10) Pub. No.: US 2013/0140081 A1
(43) Pub. Date: Jun. 6, 2013

(54) COMPOSITE SLEEVE FOR A CONDUCTOR AND METHOD

(71) Applicants: Colin Hamer, Noblesville, IN (US); Arlen Phillip Suter, Pendleton, IN (US); Max A. Butcher, Nashville, IN (US); John Matthew Sigler, Yorktown, IN (US)

(72) Inventors: Colin Hamer, Noblesville, IN (US); Arlen Phillip Suter, Pendleton, IN (US); Max A. Butcher, Nashville, IN (US); John Matthew Sigler, Yorktown, IN (US)

(73) Assignee: REMY TECHNOLOGIES, L.L.C., Pendleton, IN (US)

(21) Appl. No.: 13/312,296

(22) Filed: Dec. 6, 2011

(51) Int. Cl. H02G 3/02

(52) U.S. Cl. 174/70 R

(57) ABSTRACT

A composite sleeve for a conductor including a conductor having an outer surface, a first sleeve positioned about the outer surface of the conductor, and a second sleeve positioned about the first sleeve. One of the first and second sleeves is formed from a compressed amide synthetic fiber. The first and second sleeves cooperate to provide protection for the conductor from external elements.

### BACKGROUND OF THE INVENTION

Exemplary embodiments pertain to the art of conductors and, more particularly, to a composite sleeve for a conductor.

Most machines employ conductors that carry signals a medium of some form from one point to another. Conductors may carry electrical currents, various fluids/gases, and or light signals, to provide power and or input to various devices. Often times, the conductors are employed in harsh environments and exposed to various external conditions that may lead to failure. Conductors may be exposed to heat, cold, chemicals, or vibration that could lead to chafing. Any one or all of the aforementioned conditions may lead to failure of the conductor. In addition, often times conductors must take complicated routs through the machine. The complicated routes may often require sharp bends that may create pinch points in the conductor.

Given all of the above, many conductors are provided with sheathing or coatings that provide protection from external elements. Electrical conductors are covered with insulation and may also be protected with various heat shrink coverings. Fuel lines, optic fibers, and other such conductors may be covered with braided sheaths formed from metal. Heat shrink tubing may be configured to resist heat and/or chemicals. Metal braided coverings provide protection from chaffing and other external forces that may act upon and damage the conductor. While numerous options currently exist, each covering possess certain drawbacks that do not meet protection requirements for many existing and future applications.

### BRIEF DESCRIPTION OF THE INVENTION

Disclosed is a composite sleeve for a conductor including a conductor having an outer surface, a first sleeve positioned about the outer surface of the conductor, and a second sleeve positioned about the first sleeve. One of the first and second sleeves is formed from a compressed amide synthetic fiber. The first and second sleeves cooperate to provide protection for the conductor from external elements.

Also disclosed is a method of covering a conductor with a composite sleeve. The method includes covering the conductor with a sleeve formed from an amide synthetic fiber impregnated with an externally activated shrinkable material, and applying an external force the amide synthetic fiber to form the first sleeve about an outer surface of the conductor.

Further disclosed is a method of covering a conductor with a composite sleeve. The method includes covering the conductor with a first sleeve formed from an amide synthetic fiber, covering the first sleeve with a second sleeve, and contracting the second sleeve to compress the first sleeve against an outer surface of the conductor.

Still further disclosed is a composite sleeve for a conductor including a compressed amide synthetic fiber impregnated with an externally activated shrinkable material.

### BRIEF DESCRIPTION OF THE DRAWINGS

The following descriptions should not be considered limiting in any way. With reference to the accompanying drawings, like elements are numbered alike:

FIG. 1 depicts a perspective view of a conductor having a composite sleeve in accordance with an aspect of the exemplary embodiment;

FIG. 2 depicts a cross-sectional view of the conductor and composite sleeve of FIG. 1;

FIG. 3 depicts a perspective view of a conductor having a composite sleeve in accordance with another aspect of the exemplary embodiment;

FIG. 4 depicts a cross-sectional view of the conductor and composite sleeve of FIG. 3;

FIG. 5 depicts a perspective view of a conductor having a composite sleeve in accordance with yet another aspect of the exemplary embodiment; and

FIG. 6 depicts a cross-sectional view of the conductor and composite sleeve of FIG. 5.

### DETAILED DESCRIPTION OF THE INVENTION

A detailed description of one or more embodiments of the disclosed apparatus and method are presented herein by way of exemplification and not limitation with reference to the Figures.

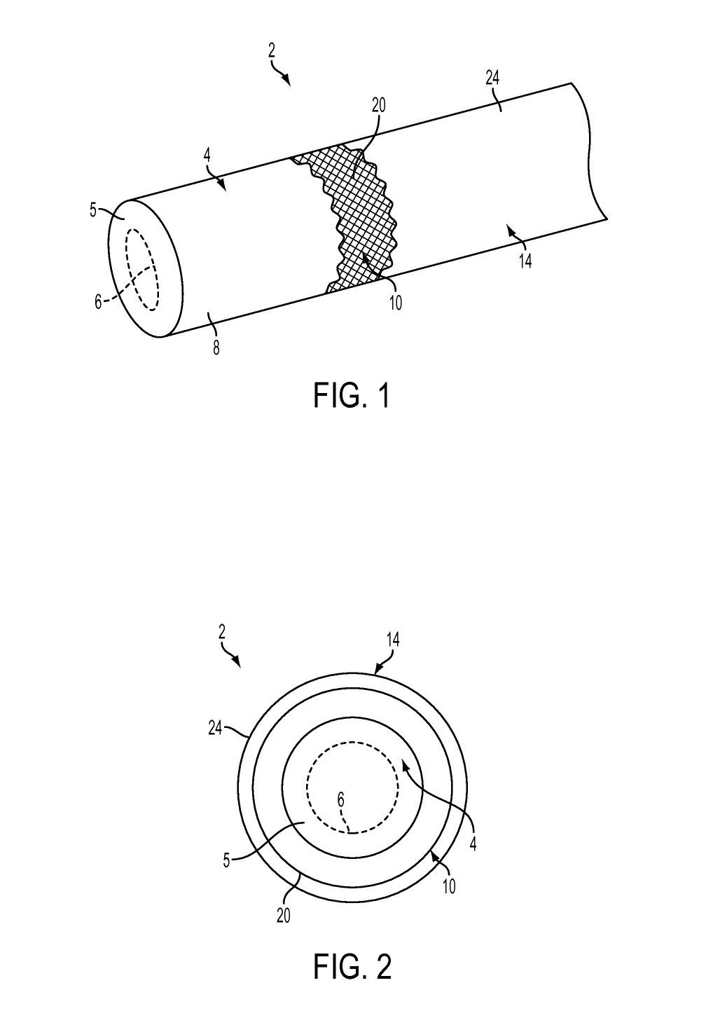

With reference to FIGS. 1 and 2, a composite sleeve in accordance with an exemplary embodiment is indicated generally at 2. Composite sleeve 2 is provided on a conductor 4 having a solid core 5. However, it should be understood that conductor 4 could be provided with an internal passage 6 that transports liquids and/or gasses. Thus, the term conductor should be understood to include any member capable of carrying electrical current, liquid, gas, light signals and the like. Regardless of form, conductor 4 includes an outer surface 8 covered by composite sleeve 2. In the exemplary embodiment shown, composite sleeve 2 includes a first sleeve 10 and a second sleeve 14.

First sleeve 10 is formed from a braided para-aramide synthetic fiber 20. More specifically, first sleeve 10 is formed from an amide synthetic fiber 20 having a —C(═O)N— chain. Examples of amides having a —C(═O)N— chain include polyimides such as Kapton®, and aramids including para-aramids such as poly-paraphenylene terephthalamide or Kevlar®, and meta-aramids such as Nomex®. More specifically, first sleeve 10 is formed from a high strength/high temperature material that is stronger than steel on an equal weight basis. Of course, it should be understood that other braided amide synthetic fibers having substantially similar general qualities could also be employed as discussed above. In accordance with one aspect of the exemplary embodiment, amide synthetic fiber 20 is loosely woven or braided to aid in compression and bending. That is, first sleeve 10 follows a contour of phase conductor 84 and thus is required to include multiple bends. Second sleeve 14 is formed from an externally activated shrinkable material 24. In accordance with one example, the externally activated shrinkable material 24 could take the form of heat shrinkable tubing. However, other externally activated shrinkable materials could also be employed. The term externally activated should be construed to include both temperature and light activated materials, as well as materials activated by exposure to gases or other substances.

First sleeve 10 is applied to outer surface 8 of conductor 4. Second sleeve 14 is applied over first sleeve 10. Eternally activated shrinkable material 24 is activated causing second sleeve 14 to contract about first sleeve 10 compressing the amide synthetic fiber 20. Once the amide synthetic fiber 20 is compressed, first and second sleeves 10 and 14 cooperate synergistically to provide mechanical strength, abrasion resistance, and insulation to conductor 4. That is, second sleeve 14 in addition to being formed from an externally activated shrinkable material may also be formed from a material that provide electrical and/or temperature insulation qualities. Second sleeve 14 may also be formed from a material resistant to a wide variety of chemicals that exposure to could degrade conductor 4. Composite sleeve 2 thus provides multiple layers of protection to conductor 4. That is, composite sleeve 2 allows conductor 4 to be installed in a wide array of operating environments that include harsh conditions such as temperature, exposure to vibration and chaffing, and exposure to harsh chemicals.

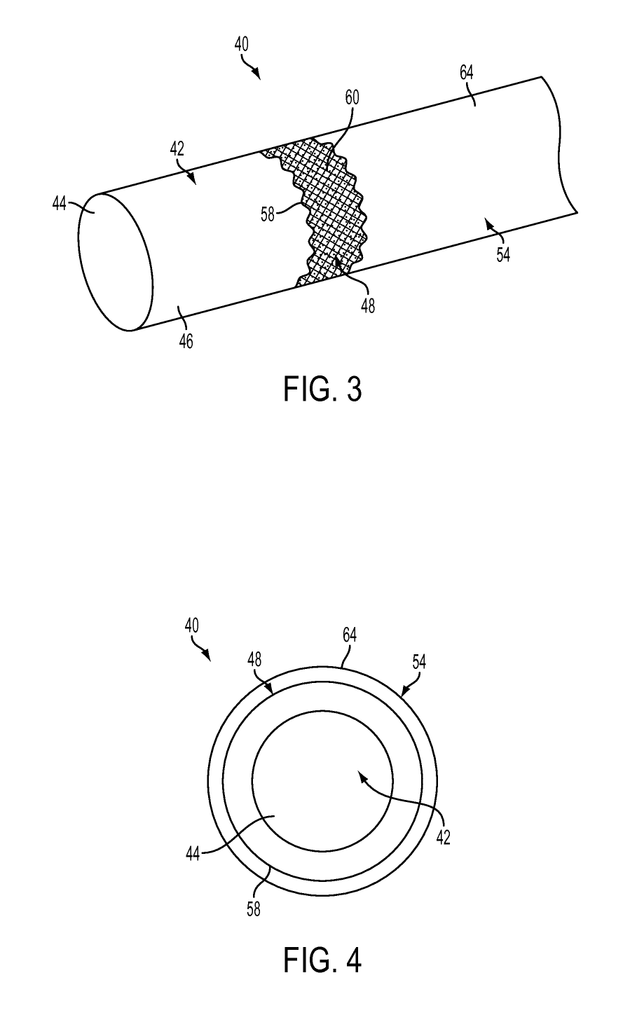

Reference will now be made to FIGS. 3 and 4 in describing a composite sleeve 40 in accordance with another aspect of the exemplary embodiment. Composite sleeve 40 is positioned about a conductor 42 having a solid core 44 and an outer surface 46. Of course, in a manner similar to that described above, conductor 42 could include an internal passage (not shown). Composite sleeve 40 includes a first sleeve 48 and a second sleeve 54. First sleeve 48 is formed from an amide synthetic fiber 58 impregnated with an externally activated shrinkable material 60. In a manner similar to that discussed above, externally activated shrinkable material 60 takes the form of a heat shrinkable material. However, other activation means can also be employed. In the exemplary embodiment shown, second sleeve 54 is also formed from an externally activated shrinkable material 64.

In accordance with the above arrangement, first sleeve 48 is positioned about outer surface 46 of conductor 42. Once in position, externally activated shrinkable material 60 is activated causing first sleeve 48 to contract about outer surface 46 of conductor 42. Second sleeve 54 is positioned about first sleeve 48 and activated. Second sleeve 54 contracts about and further compresses first sleeve 48. In this manner, first sleeve 48 provides abrasion resistance and mechanical strength, while second sleeve 54 provides insulation and protection from external influences.

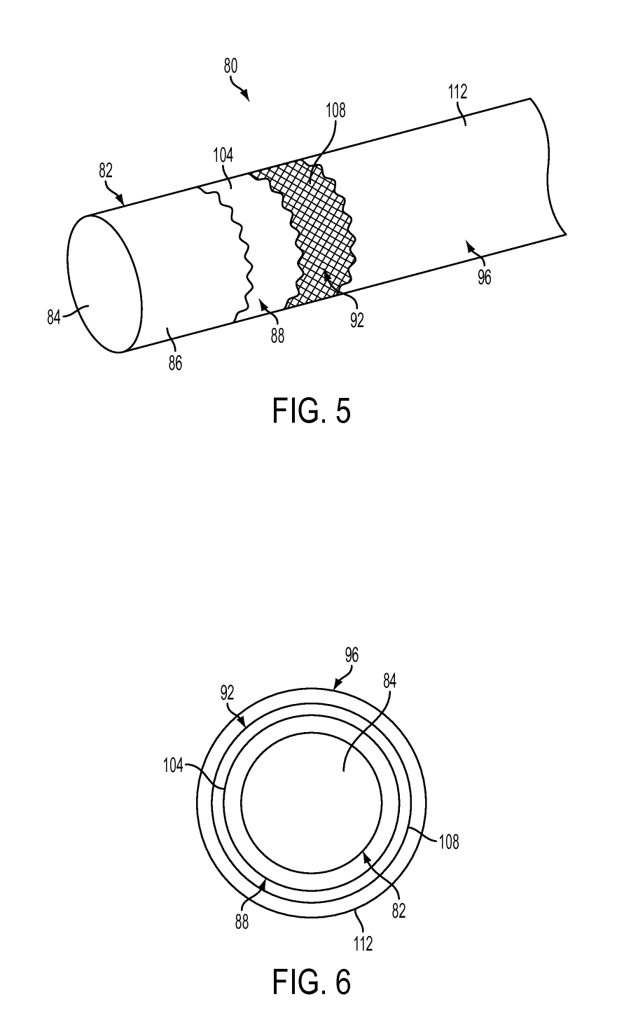

Reference will now follow to FIGS. 5 and 6 in describing a composite sleeve 80 formed in accordance with another aspect of the exemplary embodiment. Composite sleeve 80 is provided about a conductor 82 having a solid core 84 and an outer surface 86. Of course, it should be understood that conductor 82 could be provided with an internal passage for carrying fluids, gases and the like. Composite sleeve 80 extends about outer surface 86 and includes a first sleeve 88, a second sleeve 92, and a third sleeve 96.

First sleeve 88 is formed from an externally activated shrinkable material 104. In a manner similar to that discussed above, externally activated shrinkable material 104 takes the form of a heat shrinkable material. However, other activation means can also be employed. Second sleeve 92 is formed from an amide synthetic fiber 108, and third sleeve 96 is formed from an externally activated shrinkable material 112 that may or may not be similar to first sleeve 88. With this arrangement, first sleeve 88 is positioned about outer surface 86 and externally activated shrinkable material 104 is activated. First sleeve 88 contracts about outer surface 86 providing a first protective layer to conductor 82. Second sleeve 92 is positioned about first sleeve 88 and third sleeve 96 is positioned about second sleeve 92. Third sleeve 96 is exposed to an activation input and compressed about second sleeve 92 and first sleeve 88 to form composite sleeve 80.

At this point it should be understood that the exemplary embodiments describe a composite sleeve that includes a layer of compressed amide synthetic fibers. The amide fibers may be self compressed, that is compressed by an externally activated material impregnated into the amide fibers, or by an additional outer layer. Regardless, the amide fiber layer and additional layers provide mechanical strength, abrasion resistance, and/or electrical insulation, and resistance to a wide variety of external environmental conditions such as temperature, chemicals, liquids and the like. A conductor provided with a composite sleeve formed in accordance with the exemplary embodiment can be incorporated into a wide variety of applications where high mechanical strength, abrasion resistance, and/or electrical insulation as well as resistance to other external environmental factors are desired.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A composite sleeve for a conductor comprising:
a conductor having an outer surface;
a first sleeve positioned about the outer surface of the conductor; and
a second sleeve positioned about the first sleeve, one of the first and second sleeves being formed from a compressed amide synthetic fiber, the first and second sleeves cooperating to provide protection for the conductor from external elements.

2. The composite sleeve according to claim 1, wherein the other of the first and second sleeves is formed from an externally activated shrinkable material.

3. The composite sleeve according to claim 1, wherein the first sleeve is formed from the amide synthetic fiber and the second sleeve is formed from an externally activated shrinkable material.

4. The composite sleeve according to claim 2, wherein amide synthetic fiber forming the first sleeve is impregnated with an externally activated shrinkable material.

5. The composite sleeve according to claim 1, wherein the first sleeve is formed from a heat shrinkable material and the second sleeve is formed the amide synthetic fiber.

6. The composite sleeve according to claim 5, further comprising: a third sleeve extending about the second sleeve, the third sleeve being formed from an externally activated shrinkable material.

7. The composite sleeve according to claim 2, wherein the externally activated shrinkable material is heat activated.

8. The composite sleeve according to claim 1, wherein the conductor is configured and disposed to conduct an electrical current.

9. The composite sleeve according to claim 1, wherein the conductor is configured and disposed to conduct one of a fluid and a gas.

10. The composite sleeve according to claim 1, wherein the conductor is configured and disposed to conduct light signals.

11. A method of covering a conductor with a composite sleeve, the method comprising:
covering the conductor with a sleeve formed from an amide synthetic fiber impregnated with an externally activated shrinkable material; and
applying an external force the amide synthetic fiber to form the first sleeve about an outer surface of the conductor.

12. The method of claim 11, wherein applying the external force to the amide synthetic fiber includes applying heat to the amide synthetic fiver to active the externally activated shrinkable material.

13. The method of claim 11, further comprising: covering the sleeve with another sleeve formed from another externally activated shrinkable material.

14. The method of claim 13, further comprising: applying an external force to another sleeve to activate the externally activated shrinkable material.

15. The method of claim 11, further comprising: covering the conductor with a layer of insulation prior to covering the conductor with the sleeve.

16. A method of covering a conductor with a composite sleeve, the method comprising:
covering the conductor with a first sleeve formed from an amide synthetic fiber;
covering the first sleeve with a second sleeve; and
contracting the second sleeve to compress the first sleeve against an outer surface of the conductor.

17. The method of claim 16, wherein contracting the second sleeve includes applying heat to the second sleeve, the second sleeve being formed from a heat shrinkable material.

18. The method of claim 16, further comprising: covering the conductor with a third sleeve prior to covering the conductor with the first and second sleeves.

19. The method of claim 18, further comprising: contracting the third sleeve about an outer surface of the conductor.

20. A composite sleeve for a conductor comprising:
a sleeve formed from a compressed amide synthetic fiber impregnated with an externally activated shrinkable material.
